(19) United States
(12) Patent Application Publication
(10) Pub. No.: US 2007/0115778 A1
(43) Pub. Date: May 24, 2007

(54) Physical identification of an optical disc

(75) Inventor: Eric L. Kobrin, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/284,255

(22) Filed: Nov. 21, 2005

(51) Int. Cl. G11B 7/00

(52) U.S. Cl. 369/53.2

(57) ABSTRACT

A system for identifying an optical disc is provided that includes a set of physical identifiers whose arrangement defines a particular disc type. The set physical identifiers are capable of physical coupling with a set of physical attributes of an optical disc of the particular disc type. An optical disc is provided that includes a readable portion of the optical disc comprising a recording medium and a non-readable portion of the optical disc having physical attributes whose arrangement define a disc type.

### BACKGROUND OF THE INVENTION

1. Field of the Invention

The field of the invention is object identification, or, more specifically, methods, systems, and optical discs useful in identifying an optical disc of an optical disc type.

2. Description Of Related Art

Current methods for identifying the type of an optical disc, such as the content recorded on the optical disc or the owner of the optical disc, often require a user to read the contents of the recorded digital content of the disc, read a label on the optical disc, or read a label on a jewel case containing the optical disc. Such methods often rely on accuracy of a user making the identification.

Other methods for identifying optical discs including labeling disc receiving devices such as jewel cases in which the optical discs are stored. Such methods rely on accuracy of a user storing the optical disc in the jewel case. Users often improperly return optical discs to the jewel cases. Finding optical discs that are improperly stored may be difficult and time consuming.

### SUMMARY OF THE INVENTION

A method for identifying an optical disc that does not rely on user accuracy or electronic identification is provided that includes engaging a set of physical identifiers of a disc identification system with a set of physical attributes of the optical disc, determining that the optical disc is of a particular disc type if the set of physical identifiers of the disc identification system physically couple with the set of physical attributes of the optical disc, and determining that the optical disc is not of a particular disc type if the set of physical identifiers of the disc identification system do not physically couple with the set of physical attributes of the optical disc.

A system for identifying an optical disc is provided that includes a set of physical identifiers whose arrangement defines a particular disc type. The set physical identifiers are capable of physical coupling with a set of physical attributes of an optical disc of the particular disc type.

An optical disc is provided that includes a readable portion of the optical disc comprising a recording medium and a non-readable portion of the optical disc having physical attributes whose arrangement define a disc type.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a line drawing of an optical disc according to embodiments of the present invention.

FIG. 2 sets forth a line drawing illustrating a system for identifying an optical disc according to the present invention.

FIG. 3 sets forth a line drawing illustrating an exemplary jewel case having a disc identification system of the present invention.

FIG. 4 sets forth a line drawing of a jewel case that will not properly close unless a disc of the proper disc type is stored within it.

FIG. 5 sets forth a line drawing of a cross section of the disc identification system useful in a jewel case requiring rotation to close.

FIG. 6 sets forth a line drawing of a set of spindles that when rotated relative to one another engage closely thereby allowing a jewel case requiring rotation to properly close.

FIG. 7 sets forth a flow chart illustrating an exemplary method for identifying an optical disc.

### DETAILED DESCRIPTION OF EXEMPLARY EMBODIMENTS

### DETAILED DESCRIPTION

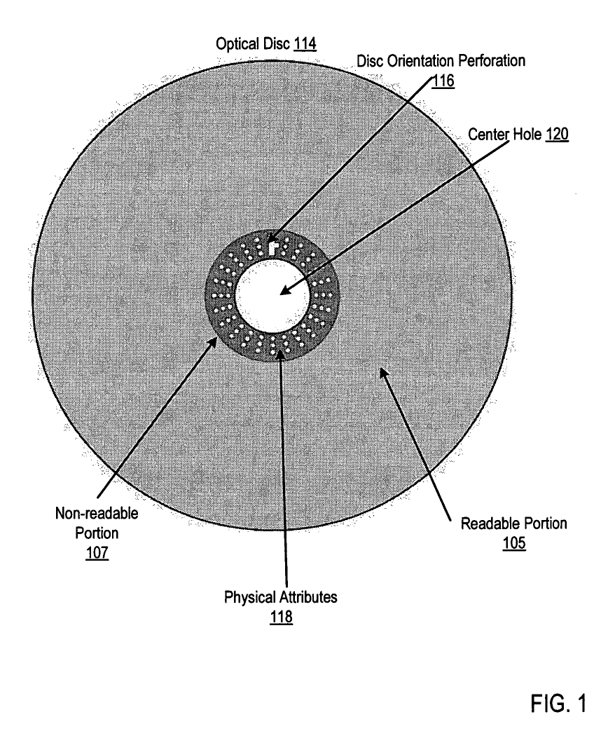

A method, system, and optical disc for identifying an optical disc according to the present invention are described with reference to the accompanying drawings, beginning with FIG. 1. FIG. 1 sets forth a line drawing of an optical disc (114) according to embodiments of the present invention. An optical disc is an electronic data storage medium that can be written to and read from using a low-powered laser beam. Examples of optical discs include compact discs (‘CDs’), video laser discs, digital versatile discs (‘DVD’s), as well as other optical discs that will occur to those of skill in the art. The optical disc (114) of FIG. 1 includes a readable portion (105) of the optical disc (114). The readable portion (105) of the optical disc (114) implements a recording medium capable of being written to and read from using a low-powered laser beam.

The optical disc (114) of FIG. 1 also includes a non-readable portion (107). The non readable portion (107) of the optical disc (114) is located within the center of the optical disc and has a center hole (120) within the center of the optical disc. The center hole (120) of the optical disc is capable of receiving a spindle of an optical disc jewel case. Such an optical disc jewel case is useful for storage of the optical disc.

The non-readable portion of the optical disc (114) of FIG. 1 also has a plurality of physical attributes (118). The arrangement of the plurality of physical attributes of the non-readable portion of the optical disc define a disc type and may be therefore used to identify the optical disc as being of the disc type so defined by the physical attributes. That is, the configuration of the physical attributes of the non-readable portion of the optical disc are unique to discs of a particular disc type. Examples of disc types include the specific content recorded on the disc, a kind of content recorded on the disc, the owner of the optical disc, or any other disc type that will occur to those of skill in the art.

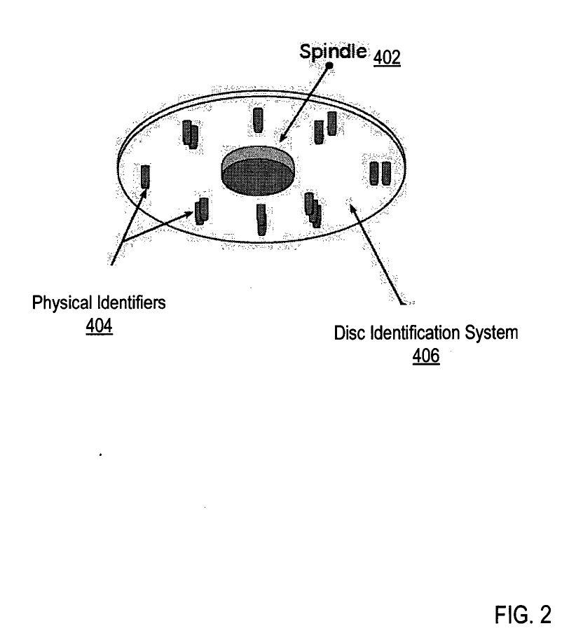

The physical attributes (118) whose arrangement define a disc type of the optical disc (114) of FIG. 1 are implemented as a plurality of perforations in the non-readable portion (107) of the optical disc whose arrangement defines a disc type. The plurality of perforations in the non-readable portion (107) are capable of physical coupling with a set of physical identifiers (404 on FIG. 2) of a disc identification system (406 on FIG. 2). The set of physical identifiers of such a disc identification system are also unique to a particular disc type. A disc identification system may be used to determine whether a disc is of a particular disc type.

To identify the disc type of the optical disc (114) of FIG. 1, the optical disc is engaged with a disc identification system, such as the disc identification system of FIG. 2. If, upon engagement of the optical disc and the disc identification system, the set of physical identifiers (406 on FIG. 2) of the disc identification system (406 on FIG. 2) physically couple with the set of physical attributes (118) of the optical disc (114) then the optical disc (114) is of a particular disc type (706) unique to the disc identification system. If the set of physical identifiers (404 on FIG. 2) of the disc identification system (406 on FIG. 2) do not physically couple with the set of physical attributes (118) of the optical disc (114) then the optical disc (114) is not of the particular disc type identified by the disc identification system of FIG. 2.

To facilitate the proper alignment between the physical attributes (118) of the optical disc of FIG. 1 and the disc identification system of FIG. 2, the optical disc (114) FIG. 1 further comprises a disc orientation perforation (116). Such a disc orientation perforation typically cooperates with a disc orientier in a disc identification system to facilitate proper engagement of physical attributes (118) of an optical disc (114) and the physical identifiers of a properly matching disc identification device.

As mentioned above, the a set of physical attributes (118) of the optical disc (114) of FIG. 1 are capable of physical coupling with a set physical identifiers (404 on FIG. 2) of a particular disc identification system used to identify disc types of a disc. For further explanation, therefore, FIG. 2 sets forth a line drawing illustrating a system (406) for identifying an optical disc according to the present invention. The disc identification system (406) of FIG. 2 includes a set of physical identifiers (404) whose arrangement defines a particular disc type. The set physical identifiers (404) are capable of physical coupling with a set of physical attributes (118 on FIG. 1) of an optical disc (114 on FIG. 1) of the particular disc type.

The set of physical identifiers (404) of the disc identification system (406) of FIG. 2 are implemented as a plurality of pins whose arrangement defines a particular disc type. The plurality of pins of the disc identification system of FIG. 2 are designed to physically couple with a set of physical attributes of an optical disc implemented as perforations in the non-readable portion of the optical disc.

The disc identification system (406) for identifying an optical disc of FIG. 2 is capable of identifying an optical disc of a particular disc type upon the engagement of an optical disc an the disc identification system. The disc identification system of FIG. 2 is capable of determining that the optical disc is of a particular disc type if the set of physical identifiers (406) of a disc identification system (406) physically couple with the set of physical attributes of the optical disc. The disc identification system (406) is capable of determining that the optical disc is not of a particular disc type if the set of physical identifiers (404) of the disc identification system (406) do not physically couple with the set of physical attributes of the optical disc. The disc identification system (406) of FIG. 2 provides a vehicle for identifying, for example, the content of the disc, the type of the disc, the owner of the disc, and other aspects of the disc that does not require reading the contents digitally stored on the disc or reading a label attached to the disc.

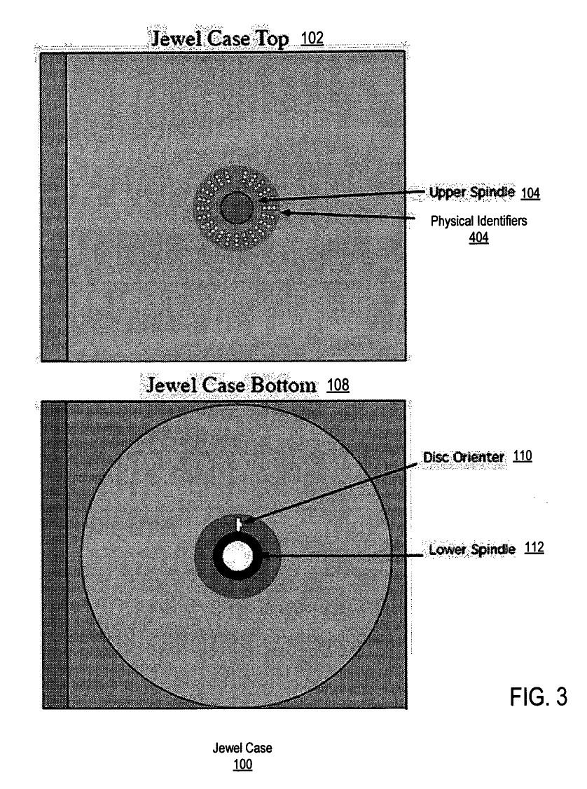

A disc identification system, such as, the system (406) of FIG. 2 may be usefully integrated with a disc receiving device such as, for example, a jewel case used for storing optical discs of a particular disc type. For further explanation, therefore, FIG. 3 sets forth a line drawing illustrating an exemplary jewel case (100) integrated within it a disc identification system of the present invention. The exemplary jewel case (100) of FIG. 3 includes a jewel case top (102) and a jewel case bottom (108) designed to engage one another and store between them an optical disc. The jewel case top (102) of FIG. 3 includes an upper spindle (104) that is capable of engaging a lower spindle (112) of the jewel case bottom (108). The upper spindle (104) of the jewel case (I 00) of FIG. 3 is capable of receiving the center hole (120 on FIG. 1) of an optical disc.

The jewel case top (102) also includes a set of physical identifiers (404) for a disc type that are capable of physical coupling with a set of physical attributes (118 of FIG. 1) of an optical disc (114 of FIG. 1) of a particular disc type identified by the disc identification system integrated within the jewel case (100) of FIG. 3. The jewel case bottom (108) of the jewel case (100) of FIG. 3 also includes a disc orienter (110) capable of cooperating with a disc orientation perforation (116 on FIG. 1) to facilitate proper alignment between an optical disc and the jewel case to facilitate coupling of physical attributes (118 on FIG. 1) of an optical disc and the physical identifiers (404) of the disc identification device integrated within the jewel case of FIG. 3.

The jewel case of FIG. 3 having integrated within it is capable of identifying an optical disc upon engaging a set of physical identifiers of a disc identification system with a set of physical attributes of the optical disc. If the set of physical identifiers of a disc identification system physically couple with the set of physical attributes of the optical disc then the optical disc is determined to be of a particular disc type defined by the jewel case. If the set of physical identifiers of the disc identification system do not physically couple with the set of physical attributes of the optical disc then the optical disc is determined to not be of a particular disc type

A disc receiving device such as the jewel case (100) may provide increased speed in identifying discs of a particular disc type. Such a jewel case may also be designed to demonstrate that a disc of a particular disc type is stored within the jewel case. To do so, a jewel case may be designed such that the jewel case will not properly close unless a disc of the proper disc type is stored within it. Jewel cases so designed identify optical discs to users simply by being closed. Such jewel cases identify an optical disc without requiring a user to even open the jewel case.

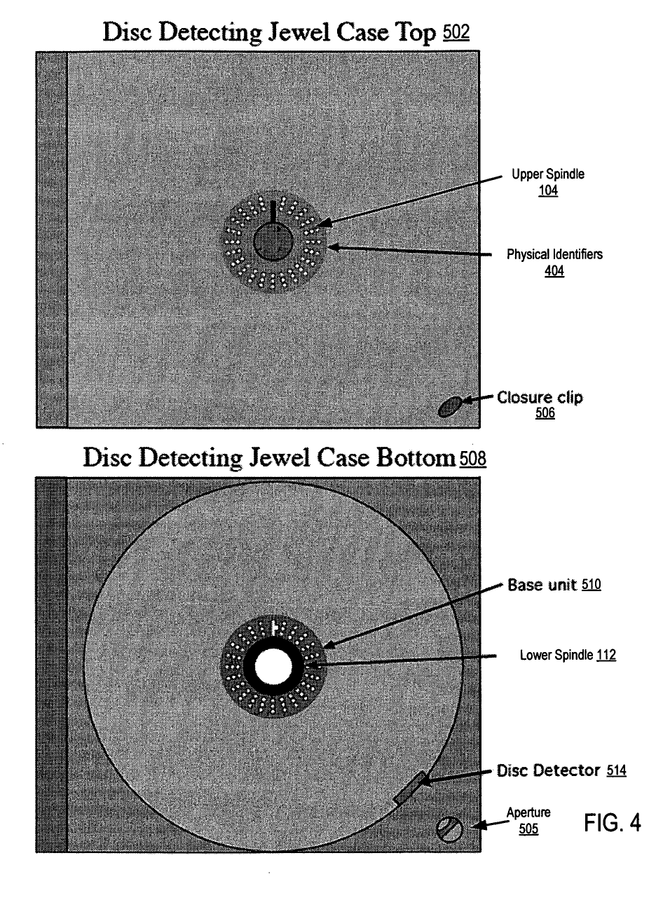

For further explanation, FIG. 4 sets forth a line drawing of a jewel case that will not properly close unless a disc of the proper disc type is stored within it. The disc detecting jewel case of FIG. 4 includes a disc detecting jewel case top (502) and a disc detecting jewel case bottom (508) designed to engage one another and store between them an optical disc.

The disc detecting jewel case top (502) of FIG. 4 includes an upper spindle (104) that is capable of engaging a lower spindle (112) of the base unit (510) of the disc detecting jewel case bottom (508). The upper spindle (104) of the disc detecting jewel case top (502) of FIG. 3 is capable of receiving the center hole (120 on FIG. 1) of an optical disc.

The disc detecting jewel case top (502) also includes a set of physical identifiers (404) for a disc type that are capable of physical coupling with a set of physical attributes (118 of FIG. 1) of an optical disc (114 of FIG. 1) of a particular disc type identified by the disc identification system integrated within the disc detecting jewel case of FIG. 4. The jewel case of FIG. 4 is capable of identifying an optical disc upon engaging the set of physical identifiers with a set of physical attributes of the optical disc. If the set of physical identifiers physically couple with the set of physical attributes of the optical disc then the optical disc is determined to be of a particular disc type defined by the jewel case. If the set of physical identifiers of the disc identification system integrated within the jewel case do not physically couple with the set of physical attributes of the optical disc then the optical disc is determined to not be of a particular disc type.

To prevent the jewel case of FIG. 4 from properly closing unless an optical disc of the proper disc type is stored within it, the disc detecting jewel case bottom (508) of FIG. 4 includes a disc detector (514). The disc detector (514) is capable of moving within the disc detecting jewel case bottom (508) to reveal an aperture (505) when a disc of the proper disc type is stored within the disc detecting jewel case and the set of physical identifiers (404) are coupled with a set of physical attributes (118 of FIG. 1) of an optical disc (114 of FIG. 1) of the proper disc type. When the aperture (505) is revealed the closure clip (506) of the disc detecting jewel case top (502) is capable of engaging the aperture (505) and the disc detecting jewel case may be closed. When no disc of the proper disc type is stored in the jewel case of FIG. 4 the aperture (505) is blocked and the closure clip (506) of the disc detecting jewel case top (502) is prevented from engaging the aperture (505) and the disc detecting jewel case is prevented from closing properly. In the example of FIG. 4 no optical disc is currently stored in the disc detecting jewel case and therefore the aperture (505) is blocked by the disc detector (514) and the disc detecting jewel case cannot be properly closed.

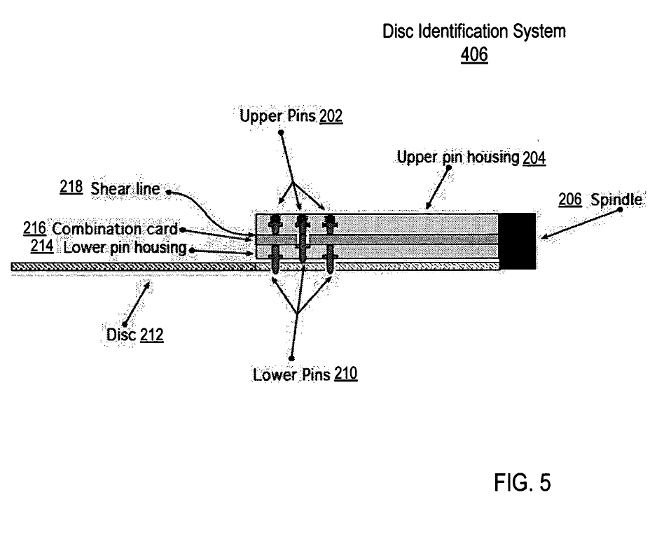

The disc detecting jewel case of FIG. 4 usefully uses a closure clip and aperture to close the jewel case when an optical disc of the proper optical disc type is properly stored within the case. Other disc detecting jewel cases may usefully use rotation to prevent closing the jewel case unless an optical disc of the proper disc type is stored within the jewel case. For further explanation, therefore, FIG. 5 sets forth a line drawing of a cross section of a disc identification system for integration within a jewel case that will only rotate when an disc of the proper disc type is engaged with the disc identification system (406).

The disc identification system (406) of FIG. 5 includes a set of spring activated upper pins (202) in an upper pin housing (204) and a set of spring activated lower pins (210) in a lower pin housing. The upper pins (202) and the lower pins (210) are separated by a combination card (216) defining the arrangement of the physical identifiers that define the disc type identified by the disc identification system (406). When the disc identification system (406) is properly engaged with a disc (212), as it is in the example of FIG. 5, the upper pins (202) are all supported at the shear line (218) allowing the upper pin housing (204) to rotate relative to the lower pin housing (214). When the disc identification system (406) is not properly engaged with an optical disc (212) of the proper disc type, the upper pins (202) are not all supported at the shear line (218) thereby preventing the upper pin housing (204) from rotating relative to the lower pin housing (214).

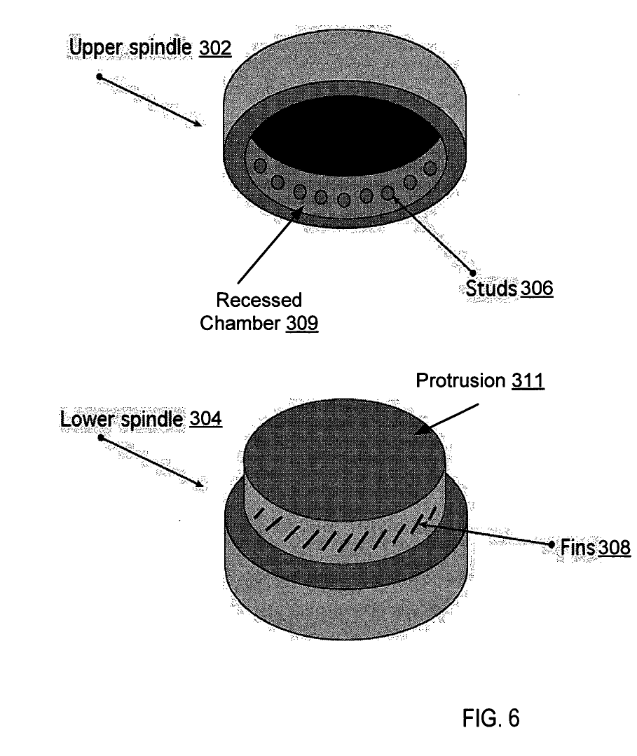

Allowing the upper pin housing to rotate relative to the lower pin housing provides a vehicle for preventing two spindles of a jewel case from rotating relative to one another unless an optical disc of the proper disc type is engaged in the disc identification system of the jewel case. To close such a jewel case using rotation, spindles are designed to engage upon rotation thereby pulling the jewel case closed. For further explanation, FIG. 6 sets forth a line drawing of a set of spindles that when rotated relative to one another engage thereby allowing a jewel case requiring rotation to properly close. The example of FIG. 6 includes an upper spindle (302) having a set of studs (306) within a recessed chamber (309). The example of FIG. 6 also includes a lower spindle (304) having a plurality of fins (308) upon a protrusion (311) designed to fit within the recessed chamber (309) of the upper spindle (302). The fins (308) are set in angles such that the studs (306) rest upon the top of the fins until they are rotated relative to the fins (308). Upon rotation, each stud (306) is lowered by the rotation and guided by the fins on either side of a stud causing the upper spindle (302) and the lower spindle (304) to be pulled toward one another thereby by allowing a jewel case employing such spindles to properly close.

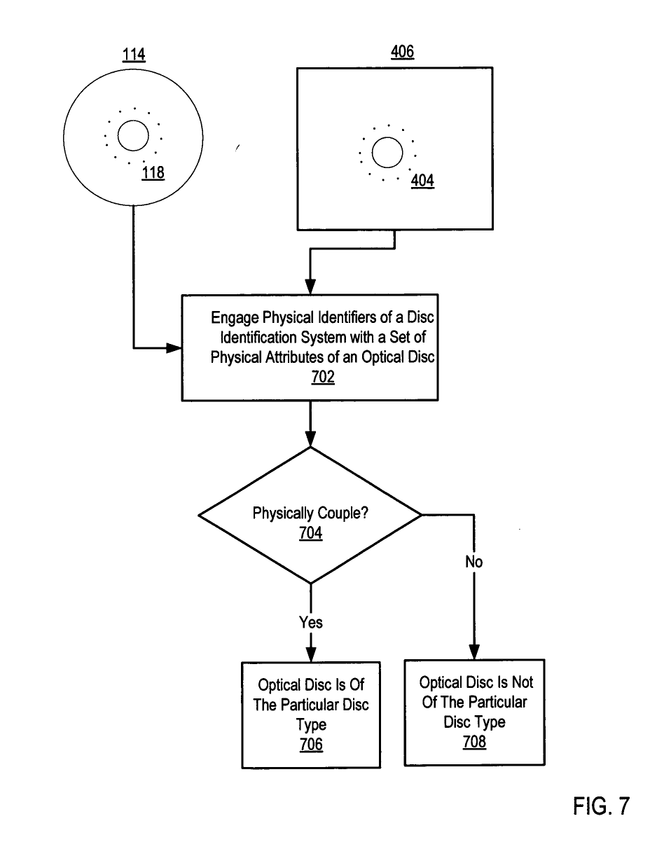

For further explanation, FIG. 7 sets forth a flow chart illustrating an exemplary method for identifying an optical disc according to the present invention. The method of FIG. 7 includes engaging (702) a set of physical identifiers (404) of a disc identification system (406) with a set of physical attributes (118) of the optical disc (114). The set of physical identifiers (404) of the disc identification system (406) comprise physical identifiers for a disc type capable of physical coupling with a set of physical attributes (118) of an optical disc (114) of a particular disc type. One example of a set of physical identifiers (404) for a disc type capable of physical coupling with a set of physical attributes (118) of an optical disc (114) include a plurality of pins capable of coupling with a plurality of perforations whose arrangement defines a disc type as discussed above. Engaging a set of physical identifiers of a disc identification system with a set of physical attributes of the optical disc in such cases may be carried out by receiving within the set of physical attributes implemented as protrusions in the non-readable portion of the optical disc the physical identifiers implemented as a set of pins of a disc identification system.

The method of FIG. 7 includes determining (704) that the optical disc (114) is of a particular disc type (706) if the set of physical identifiers (404) of a disc identification system (406) physically couple with the set of physical attributes (118) of the optical disc (114). As discussed above, to facilitate determining that the set of physical identifiers (404) of a disc identification system (406) physically couple with the set of physical attributes (118) of the optical disc (114) disc receiving devices according to the present invention such as jewel cases may be designed to close only when an optical discs of the proper optical disc type are stored within the jewel cases.

The method of FIG. 7 includes determining (704) that the optical disc (114) is not of a particular disc type (708) if the set of physical identifiers (404) of the disc identification system (406) do not physically couple with the set of physical attributes (118) of the optical disc (114). As discussed above, to facilitate determining that the set of physical identifiers (404) of a disc identification system (406) do no physically couple with the set of physical attributes (118) of the optical disc (114), disc receiving devices according to the present invention such as a jewel cases may be designed to prevent closing when optical discs of an improper optical disc type are stored within the jewel cases.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for identifying an optical disc, the method comprising:
engaging a set of physical identifiers of a disc identification system whose arrangement define a disc type with a set of physical attributes of the optical disc;
determining that the optical disc is of a particular disc type if the set of physical identifiers of a disc identification system physically couple with the set of physical attributes of the optical disc; and
determining that the optical disc is not of a particular disc type if the set of physical identifiers of the disc identification system do not physically couple with the set of physical attributes of the optical disc.

2. The method of claim 1 wherein the set of physical identifiers of the disc identification system further comprise a plurality of pins whose arrangement defines a disc type.

3. The method of claim 1 wherein the set of physical attributes of the optical disc further comprises a plurality of perforations whose arrangement defines a disc type.

4. The method of claim 1 wherein engaging a set of physical identifiers of a disc identification system with a set of physical attributes of the optical disc further comprises receiving within the set of physical attributes of the optical disc the physical identifiers of a disc identification system.

5. The method of claim 4 wherein determining that the optical disc is of a particular disc type if the set of physical identifiers of a disc identification system physically couple with the set of physical attributes of the optical disc further comprises closing a jewel case coupled to the disc identification system.

6. The method of claim 1 wherein a disc type defines the content recorded on the optical disc.

7. The method of claim 1 wherein a disc type defines the owner of the optical disc.

8. A system for identifying an optical disc, the system comprising:
a set of physical identifiers whose arrangement defines a particular disc type; and
wherein the set physical identifiers are capable of physical coupling with a set of physical attributes of an optical disc of the particular disc type.

9. The system of claim 8 wherein the set of physical identifiers further comprise a plurality of pins whose arrangement defines a particular disc type.

10. The system of claim 8 further comprising a disc receiving device coupled with the set physical identifiers.

11. The system of claim 8 wherein the disc receiving device further comprises a disc orienter.

12. The system of claim 11 wherein the disc receiving device further comprises an optical disc jewel case.

13. The system of claim 12 wherein the disc receiving device is rotatably coupled to the set of physical identifiers whose arrangement defines a particular disc type.

14. The system of claim 8 wherein a disc type defines the content recorded on an optical disc.

15. The system of claim 8 wherein a disc type defines the owner of the optical disc.

16. An optical disc comprising:
a readable portion of the optical disc comprising a recording medium; and
a non-readable portion of the optical disc having physical attributes whose arrangement define a disc type.

17. The optical disc of claim 16 wherein the physical attributes whose arrangement define a disc type further comprises perforations in the non-readable portion of the optical disc capable of physical coupling with a set of physical identifiers of a disc identification system.

18. The optical disc of claim 16 wherein the physical attributes whose arrangement define a disc type further comprises a disc orientation perforation.

19. The optical disc of claim 16 wherein a disc type defines the content recorded on the disc.

20. The optical disc of claim 16 wherein a disc type defines the owner of the disc.
